(19) United States
(12) Patent Application Publication
(10) Pub. No.: US 2020/0234859 A1
(43) Pub. Date: Jul. 23, 2020

(54) OIL-BASED MAGNETIC INK

(71) Applicant: RISO KAGAKU CORPORATION, Tokyo (JP)

(72) Inventors: Kenji YAMADA, Ibaraki (JP); Hajime TSUNODA, Ibaraki (JP); Tetsuya SHIRAISHI, Ibaraki (JP)

(21) Appl. No.: 16/737,622

(22) Filed: Jan. 8, 2020

(30) Foreign Application Priority Data
Jan. 23, 2019 (JP) 2019-009469

(51) Int. Cl. H01F 1/44; C09D 11/36; C09D 11/322; C09D 11/38; C09D 11/033; C09D 11/037; B41M 5/00

(52) U.S. Cl. CPC H01F 1/445; C09D 11/36; C09D 11/322; B41M 5/0023; C09D 11/033; C09D 11/037; C09D 11/38

(57) ABSTRACT

An oil-based magnetic ink having an improved long-term storage stability is provided. The oil-based magnetic ink contains ferrite particles, a dispersant, a petroleum-based hydrocarbon solvent, a fatty acid ester-based solvent, and at least one selected from the group consisting of a glycol ether-based solvent and an alkanediol-based solvent, wherein the glycol ether-based solvent is a compound represented by R¹O—(R²O)ₘ—H where R¹ is an alkyl group having 4 to 8 carbon atoms, R² is an alkylene group having 2 or 3 carbon atoms, and m is 3 or 4, and the alkanediol-based solvent is an alkanediol-based solvent having 6 to 10 carbon atoms.

This Application is based upon and claims the benefit of priority from prior Japanese Patent Applications No. 2019-009469 filed on Jan. 23, 2019, the entire contents of which are incorporated by reference herein.

### BACKGROUND OF THE INVENTION

### FIELD OF THE INVENTION

The present invention relates to an oil-based magnetic ink.

### DESCRIPTION OF THE RELATED ART

Magnetic printing that forms a magnetic particle-containing image is known to be one type of security printing used for the printing of, e.g., checks and paper currency. The magnetic ink character recognition system (MICR) is a method for reading, with a magnetic head, magnetic information that has been printed with a magnetic ink. Magnetic particles are incorporated in this magnetic ink, and ferrite particles are generally used.

In addition to methods that use magnetic ink, methods that use a magnetic toner or a magnetic ink ribbon are heretofore known printing methods used for magnetic printing. In recent years, however, in view of, for example, printing costs, the development of inkjet printing methods using magnetic ink has been progressing. Thus, there is a demand for technology for dispersing magnetic particles in ink.

In an inkjet printing system, a highly flowable inkjet ink is ejected as droplets from a microfine nozzle to record an image on a recording medium positioned facing the nozzle, and inkjet printing systems have spread quite rapidly in recent years because they support high-speed, low-noise printing. The following are known for the ink used in such inkjet printing systems: water-based inks, which contain water as the main vehicle; ultraviolet-curable inks (UV inks), which contain a high content of polymerizable monomer as the main component; hot-melt inks (solid inks), which contain a high content of wax as the main component; and so-called non-aqueous inks, which contain a non-aqueous solvent as the main vehicle. Non-aqueous inks can be classified into solvent inks (solvent-based inks), in which the main vehicle is a volatile organic solvent, and oil-based inks (oil-based inks), in which the main vehicle is a low-volatility or nonvolatile organic solvent. Solvent inks dry on the recording medium primarily by evaporation of the organic solvent, while oil-based inks dry mainly by permeation into the recording medium.

Oil-based inkjet inks contain little volatile component in the ink, and as a result the ink undergoes little viscosity change near the left-opened head nozzle and an excellent jetting recovery can be provided. The oil component of oil-based inkjet inks exhibits little permeation into the fiber interior of the printing paper, and there is little paper curl in the printed item formed with the oil-based inkjet inks. Such oil-based inkjet inks are inks that are well adapted for high-speed inkjet printers.

Japanese Patent Application Laid-open No. 2012-193366 (Patent Document 1) proposes, as a magnetic ink that supports printing using a piezoelectric print head, an ink that uses a non-aqueous carrier and coated magnetic nanoparticles. According to the description in Patent Document 1, the coated magnetic nanoparticles, which are protected from exposure to water and air, are used in order to prevent the spontaneous combustion of microfine metal nanoparticles.

Japanese Patent Application Laid-open No. 2016-150985 (Patent Document 2) proposes that, for a solvent-based inkjet ink composition containing a solvent and a colorant such as a pigment, a balance can be struck between the drying behavior of the printed material and the wetting/spreading behavior of the ink on the media through the incorporation as solvent of at least two species of compounds represented by the general formula R¹O—(R²O)ₘ—R³ for which only the number of moles of addition of the oxyalkylene group that is the main skeleton in the structure differs by one.

### SUMMARY OF THE INVENTION

One embodiment is an oil-based magnetic ink that contains ferrite particles, a dispersant, a petroleum-based hydrocarbon solvent, a fatty acid ester-based solvent, and at least one selected from the group consisting of a glycol ether-based solvent and an alkanediol-based solvent, wherein the glycol ether-based solvent is a compound represented by R¹O—(R²O)ₘ—H where R¹ is an alkyl group having 4 to 8 carbon atoms, R² is an alkylene group having 2 or 3 carbon atoms, and m is 3 or 4, and the alkanediol-based solvent is an alkanediol-based solvent having 6 to 10 carbon atoms.

### DETAILED DESCRIPTION OF THE EMBODIMENTS

The present invention is described in the following using embodiments. The examples in the following embodiments do not limit the present invention.

The ferrite particle concentration is generally required to be increased in magnetic inks for MICR applications for characters to be read out. However, problems occur at high ferrite particle concentrations, i.e., the dispersion stability is also reduced and in particular the viscosity change during long-term storage becomes substantial and the storage stability is reduced. In addition, ferrite particles have a higher specific gravity than the pigments used in ordinary inks, and as a consequence the storage stability is made even more problematic.

In Patent Document 1, various solvents are provided as examples for the solvent in the magnetic ink, but petroleum-based hydrocarbon solvents are used in the Examples. Petroleum-based hydrocarbon solvents are low-polarity solvents and as a result the dispersant is less soluble therein, and the problem then maybe occurs that the dispersing effect is not obtained to the expected degree.

In Patent Document 2, because only a high-polarity solvent is used, problems may be produced with regard to maintaining the dispersion stability of the pigment particles on a long-term storage. A problem also occurs with the solvent composition described in Patent Document 2 in that it is difficult to secure dispersion stability for particles having a large specific gravity, such as ferrite particles.

An object of the present invention is to provide an oil-based magnetic ink having an improved long-term storage stability.

The oil-based magnetic ink according to one embodiment (also referred to hereafter simply as “the ink” or “the magnetic ink”) contains ferrite particles, a dispersant, a petroleum-based hydrocarbon solvent, a fatty acid ester-based solvent, and at least one selected from the group consisting of a glycol ether-based solvent and an alkanediol-based solvent, wherein the glycol ether-based solvent is a compound represented by R¹O—(R²O)ₘ—H where R¹ is an alkyl group having 4 to 8 carbon atoms, R² is an alkylene group having 2 or 3 carbon atoms, and m is 3 or 4, and the alkanediol-based solvent is an alkanediol-based solvent having 6 to 10 carbon atoms.

This can provide an oil-based magnetic ink having an improved long-term storage stability.

The ferrite particle surface has a high polarity, which may be a cause of reduced dispersion stability of ferrite particles in non-aqueous solvents due to the resulting reduced wettability to non-aqueous solvents and inadequate adsorptivity of the dispersant.

By using the combination of a petroleum-based hydrocarbon solvent, which is a low-polarity component, with a fatty acid ester-based solvent, which is a high-polarity component, the polarity balance in the non-aqueous solvent as a whole can be adjusted into a preferred range and the dispersion stability of the ferrite particles can then be improved.

The glycol ether-based solvent and alkanediol-based solvent according to one embodiment exhibit respectively high-polarity, and it is thought that the affinity for the dispersant and the affinity for the ferrite particles can be enhanced. Due to this, through the incorporation in the non-aqueous solvent of at least one of the glycol ether-based solvent and the alkanediol-based solvent according to one embodiment, the solubility of the dispersant in the non-aqueous solvent can be increased and the wettability of the ferrite particles to the non-aqueous solvent can be raised. As a result, the adsorptivity of the dispersant to the ferrite particles can be further increased and the dispersion stability of the ferrite particles in the non-aqueous solvent can be further increased.

On the other hand, since the ferrite particles has frequently large specific gravity, the ferrite particles may tend to sediment in non-aqueous solvents and a concentration gradient of the ferrite particles may be generated. In contrast to this, by the addition of at least one of the glycol ether-based solvent and the alkanediol-based solvent according to one embodiment, the long-term dispersion stability of the ferrite particles can be improved even if a concentration gradient is generated.

The magnetic ink preferably contains ferrite particles.

Ferrite particles are particles formed using a ferrate (III) salt of a divalent transition metal, e.g., Mn, Fe, Co, Ni, Cu, Zn, Ba, Sr, and Pb, and can exhibit ferrimagnetism.

Magnetite, cobalt ferrite, manganese-cobalt ferrite, barium ferrite, and so forth can preferably be used as the ferrite particles.

The ferrite particle surface is preferably not coated with a solid, e.g., a polymer or inorganic compound. The dispersant is preferably directly adsorbed to the ferrite particles when the ferrite particle surface is not coated, and as a result the functional groups, e.g., the hydroxy group, bonded to the metal atoms, e.g., Mn, Fe, Co, can engage in, e.g., acid-base interactions with the functional groups on the dispersant and the dispersion stability of the ferrite particles can be further improved.

The average particle diameter of the ferrite particles may be, for example, 5 nm to 300 nm, and, viewed from the standpoint of the suitability of j et from the inkjet nozzle and the dispersion stability in the ink, 5 to 200 nm is preferred and 5 to 150 nm is more preferred.

Here, the average particle diameter of the ferrite particles is the average particle diameter on a volume basis as provided by a dynamic scattering procedure, and this measurement can be performed using, for example, an “SZ-100S” nanoparticle analyzer from Horiba, Ltd. The same applies in the following.

Expressed with reference to the total amount of the ink, the ferrite particles are preferably at least 1 mass %, more preferably at least 10 mass %, still more preferably at least 30 mass %, and even more preferably at least 35 mass %. This makes it possible to increase both the visibility of the printed image and the magnetic strength.

Expressed with reference to the total amount of the ink, the ferrite particles are preferably not more than 50 mass % and more preferably not more than 45 mass %. While ferrite particles have a relatively large specific gravity, an excellent dispersion stability can be maintained, even at high ferrite particle concentrations, by the use of a combination of the three types of solvents according to one embodiment.

The magnetic ink can contain at least one selected from the group consisting of a glycol ether-based solvent and an alkanediol-based solvent.

A compound represented by R¹O—-(R²O)ₘ—H is preferred for the glycol ether-based solvent.

Here, R¹ is preferably an alkyl group having 4 to 8 carbon atoms and is more preferably an alkyl group having 4 to 6 carbon atoms and may be straight chain or branched. By having the number of carbon atoms in R¹ be at least 4, the compatibility with the petroleum-based hydrocarbon solvent can be increased, the uniformity of the three types of solvents can be improved, and the storage stability of the ink can be further improved. By having the number of carbon atoms in R¹ be not more than 8, the generation of a high viscosity for the glycol ether-based solvent itself can be prevented and an increase in the viscosity of the ink as a whole can be prevented.

R¹ can be specifically exemplified by the n-butyl group, isobutyl group, sec-butyl group, tert-butyl group, pentyl group, hexyl group, heptyl group, octyl group, isooctyl group, and 2-ethylhexyl group, with the n-butyl group being preferred.

R² is preferably an alkylene group having 2 or 3 carbon atoms and can be specifically exemplified by the ethylene group, propylene group, and trimethylene group, with the ethylene group being more preferred.

m is preferably 3 or 4.

The glycol ether-based solvent according to one embodiment is preferably provided with a repeat structure of 3 or 4 ethylene glycols or propylene glycols. In this case, the generation of a high viscosity for the solvent itself can be suppressed while the affinity for the ferrite particles and the dispersant can be increased.

The glycol ether-based solvent can be specifically exemplified by triethylene glycol monoalkyl ethers, such as triethylene glycol monobutyl ether, triethylene glycol monopentyl ether, triethylene glycol monohexyl ether, triethylene glycol monoheptyl ether, triethylene glycol mono-2-ethylhexyl ether, and triethylene glycol monooctyl ether; tetraethylene glycol monoalkyl ethers, such as tetraethylene glycol monobutyl ether, tetraethylene glycol monopentyl ether, tetraethylene glycol monohexyl ether, tetraethylene glycol monoheptyl ether, tetraethylene glycol mono-2-ethylhexyl ether, and tetraethylene glycol monooctyl ether; tripropylene glycol monoalkyl ethers, such as tripropylene glycol monobutyl ether, tripropylene glycol monopentyl ether, tripropylene glycol monohexyl ether, tripropylene glycol monoheptyl ether, tripropylene glycol mono-2-ethylhexyl ether, and tripropylene glycol monooctyl ether; and tetrapropylene glycol monoalkyl ethers, such as tetrapropylene glycol monobutyl ether, tetrapropylene glycol monopentyl ether, tetrapropylene glycol monohexyl ether, tetrapropylene glycol monoheptyl ether, tetrapropylene glycol mono-2-ethylhexyl ether, and tetrapropylene glycol monooctyl ether.

Each of these glycol ether-based solvents may be used alone or two or more may be used in combination.

The alkanediol-based solvent is preferably an alkanediol-based solvent having 6 to 10 carbon atoms. For example, the alkanediol-based solvent is preferably a compound in which two hydroxy groups are bonded to a straight-chain or branched alkane having 6 to 10 carbon atoms, more preferably 8 to 10 carbon atoms.

By having the number of carbon atoms in the alkanediol-based solvent be at least 6, the compatibility with the petroleum-based hydrocarbon solvent can be increased, the uniformity of the three types of solvents can be improved, and the storage stability of the ink can be further improved. By having the number of carbon atoms in the alkanediol-based solvent be not more than 10, the alkanediol-based solvent itself can be provided with the flowability required as a solvent and an increase in the viscosity of the ink as a whole can be prevented.

Specific examples of the alkanediol-based solvents include 1,6-hexanediol, 1,7-heptanediol, 1,8-octanediol, 1,9-nonanediol, 1,10-decanediol, 1,2-hexanediol, 2,5-hexanediol, 1,2-heptanediol, 1,2-octanediol, 1,2-nonanediol, 1,2-decanediol, 2-methyl-1,5-pentanediol, 2-methyl-2,4-pentanediol, 3-methyl-1,5-pentanediol, 3-ethyl-1,5-pentanediol, 3-ethyl-2,4-pentanediol, 2-ethyl-1,3-hexanediol, 2-ethyl-2-methyl-1,3-propanediol, 2,4-dimethyl-2,4-pentanediol, 2,4-diethyl-1,5-pentanediol, 2,2-dimethyl-1,3-hexanediol, 2,5-dimethyl-2,5-hexanediol, 2,2,4-trimethyl-1,3-pentanediol, 2,2,4-trimethyl-1,6-hexanediol, and 2,4,4-trimethyl-1,6-hexanediol.

Each of these alkanediol-based solvents may be used alone or two or more may be used in combination.

The ink may contain either the glycol ether-based solvent or the alkanediol-based solvent as described above, or may contain both.

The total amount of the glycol ether-based solvent and alkanediol-based solvent according to one embodiment, expressed with reference to the total amount of the ink, is preferably at least 0.1 mass %, more preferably at least 0.5 mass %, and still more preferably at least 1 mass %. By doing this, the affinity for the ferrite particles and the dispersant can be increased and the storage stability of the ink can be further improved.

The total amount of the glycol ether-based solvent and alkanediol-based solvent according to one embodiment, expressed with reference to the total amount of the ink, is preferably not more than 10 mass %, more preferably not more than 8 mass %, and still more preferably not more than 5 mass %. By doing this, the storage stability of the ink can be further improved while maintaining the compatibility of the three or four types of solvent.

The total amount of the glycol ether-based solvent and alkanediol-based solvent according to one embodiment, expressed as the mass ratio, is preferably at least 0.01, more preferably at least 0.02, and still more preferably at least 0.03, in each case per 1 mass part of the ferrite particles.

According to an embodiment, the total amount of the glycol ether-based solvent and alkanediol-based solvent, expressed as the mass ratio, is preferably not more than 1, more preferably not more than 0.5, and still more preferably not more than 0.1, in each case per 1 mass part of the ferrite particles.

The magnetic ink preferably contains a petroleum-based hydrocarbon solvent and a fatty acid ester-based solvent in addition to at least one of the glycol ether-based solvent and the alkanediol-based solvent as described above.

The petroleum-based hydrocarbon solvent and the fatty acid ester-based solvent preferably are each a solvent that exhibits water insolubility whereby uniform mixing with an equal volume of water at 1 atmosphere and 20° C. does not occur.

The petroleum-based hydrocarbon solvent can be exemplified by aliphatic hydrocarbon solvents, alicyclic hydrocarbon solvents, and aromatic hydrocarbon solvents.

The aliphatic hydrocarbon solvents and alicyclic hydrocarbon solvents can be exemplified by paraffinic, isoparaffinic, and naphthenic non-aqueous solvents. Preferred examples of commercially available products include No. 0 solvent L, No. 0 Solvent M, No. 0 Solvent H, Cactus Normal Paraffin N-10, Cactus Normal Paraffin N-11, Cactus Normal Paraffin N-12, Cactus Normal Paraffin N-13, Cactus Normal Paraffin N-14, Cactus Normal Paraffin N-15H, Cactus Normal Paraffin YHNP, Cactus Normal Paraffin SHNP, Isosol 300, Isosol 400, Teclean N-16, Teclean N-20, Teclean N-22, AF Solvent No. 4, AF Solvent No. 5, AF Solvent No. 6, AF Solvent No. 7, Naphthesol 160, Naphthesol 200, and Naphthesol 220 (all manufactured by JXTG Nippon Oil & Energy Corporation); Isopar G, Isopar H, Isopar L, Isopar M, Exxsol D40, Exxsol D60, Exxsol D80, Exxsol D95, Exxsol D110, and Exxsol D130 (all manufactured by the Exxon Mobil Corporation); and MORESCO White P-40, MORESCO White P-60, MORESCO White P-70, MORESCO White P-80, MORESCO White P-100, MORESCO White P-120, MORESCO White P-150, MORESCO White P-200, MORESCO White P-260, and MORESCO White P-350P (all manufactured by the MORESCO Corporation).

Preferred examples of aromatic hydrocarbon solvents include Grade Alkene L and Grade Alkene 200P (both manufactured by JXTG Nippon Oil & Energy Corporation) and Solvesso 100, Solvesso 150, Solvesso 200, and Solvesso 200ND (all manufactured by JXTG Nippon Oil & Energy Corporation).

Each of these petroleum-based hydrocarbon solvents may be used alone, or combinations of two or more may be used as long as a single phase is formed.

The initial boiling point of the petroleum-based hydrocarbon solvent is preferably at least 100° C., more preferably at least 150° C., and still more preferably at least 200° C. The initial boiling point can be measured according to JIS K 0066, “Test Methods for Distillation of Chemical Products”.

The petroleum-based hydrocarbon solvent is, expressed with reference to the total amount of the ink, preferably at least 5 mass %, more preferably at least 10 mass %, and still more preferably at least 30 mass %. By incorporating a relatively low viscosity petroleum-based hydrocarbon solvent in the indicated range, the generation of a high viscosity for the ink as a whole can be prevented and the storage stability can be further improved.

The petroleum-based hydrocarbon solvent is, expressed with reference to the total amount of the ink, preferably not more than 70 mass %, more preferably not more than 50 mass %, and still more preferably not more than 45 mass %. By limiting the content of the low-polarity petroleum-based hydrocarbon solvent to the indicated range, the polarity of the solvent as a whole can be increased, the solubility of the dispersant in the solvent can be promoted, and the dispersion stability of the ferrite particles can be further improved.

The fatty acid ester-based solvent preferably has 12 to 30 and more preferably 14 to 24 carbon atoms in each molecule, and preferred examples include isononyl isononanoate, isodecyl isononanoate, ethylhexyl isononanoate, methyl laurate, isopropyl laurate, hexyl laurate, isopropyl myristate, isopropyl palmitate, hexyl palmitate, isooctyl palmitate, isostearyl palmitate, methyl oleate, ethyl oleate, isopropyl oleate, butyl oleate, hexyl oleate, methyl linoleate, ethyl linoleate, isobutyl linoleate, butyl stearate, hexyl stearate, isooctyl stearate, isopropyl isostearate, isodecyl neopentanoate, 2-octyldecyl neopentanoate, soybean oil methyl ester, soybean oil isobutyl ester, tall oil methyl ester, and tall oil isobutyl ester.

Each of these fatty acid ester-based solvents may be used alone, or a combination of two or more may be used as long as a single phase is formed.

The boiling point of the fatty acid ester-based solvent is preferably at least 150° C., more preferably at least 200° C., and still more preferably at least 250° C. Fatty acid ester-based solvents with a boiling point of at least 250° C. also encompass solvents that do not exhibit a boiling point.

The fatty acid ester-based solvent is preferably at least 1 mass %, more preferably at least 5 mass %, and still more preferably at least 10 mass %, expressed with reference to the total amount of the ink. By incorporating the high-polarity fatty acid ester-based solvent in the indicated range, the polarity of the solvent as a whole can be increased, the solubility of the dispersant in the solvent can be promoted, and the dispersion stability of the ferrite particles can be further improved.

The fatty acid ester-based solvent is, expressed with reference to the total amount of the ink, preferably not more than 50 mass %, more preferably not more than 30 mass %, and still more preferably not more than 20 mass %. By limiting the content of the relatively high viscosity fatty acid ester-based solvent to the indicated range, the generation of a high viscosity for the ink as a whole can be prevented and the storage stability can be further improved.

The total amount of the glycol ester-based solvent and alkanediol-based solvent according to one embodiment, petroleum-based hydrocarbon solvent, and fatty acid ester-based solvent is, with reference to the total amount of the ink, preferably not more than 90 mass %, more preferably not more than 80 mass %, and still more preferably not more than 70 mass %.

The total amount of glycol ester-based solvent and alkanediol-based solvent according to one embodiment, petroleum-based hydrocarbon solvent, and fatty acid ester-based solvent is, with reference to the total amount of the ink, preferably at least 40 mass % and more preferably at least 50 mass %.

The total amount of the glycol ether-based solvent and alkanediol-based solvent according to one embodiment is preferably not more than 30 mass %, more preferably not more than 20 mass %, and still more preferably not more than 10 mass %, as expressed with reference to the total amount of the glycol ester-based solvent and alkanediol-based solvent according to one embodiment, petroleum-based hydrocarbon solvent, and fatty acid ester-based solvent.

The total amount of the glycol ether-based solvent and alkanediol-based solvent according to one embodiment is preferably at least 0.5 mass %, more preferably at least 1 mass %, and still more preferably at least 3 mass %, as expressed with reference to the total amount of the glycol ester-based solvent and alkanediol-based solvent according to one embodiment, petroleum-based hydrocarbon solvent, and fatty acid ester-based solvent.

In this case, the affinity for the ferrite particles and the dispersant can be increased and the dispersion stability of the ferrite particles can be further improved by at least one of the glycol ether-based solvent and alkanediol-based solvent according to one embodiment, while maintaining compatibility among the three types of solvents.

The mass ratio between the petroleum-based hydrocarbon solvent and the fatty acid ester-based solvent is preferably 90:10 to 30:70, more preferably 80:20 to 40:60, and still more preferably 70:30 to 50:50. In this range, the polarity balance between the low-polarity petroleum-based hydrocarbon solvent and the high-polarity fatty acid ester-based solvent can be brought into a preferred range and the storage stability of the ink as a whole can be further improved.

By providing a larger amount of incorporation of the fatty acid ester-based solvent by using a mass ratio between the petroleum-based hydrocarbon solvent and the fatty acid ester-based solvent of at least 90:10 and particularly at least 80:20, the polar component in the mixed solvent can be secured, the solubility of the dispersant can be promoted, and the dispersion stability of the ferrite particles can be further improved.

By limiting the amount of incorporation of the fatty acid ester-based solvent using a mass ratio between the petroleum-based hydrocarbon solvent and fatty acid ester-based solvent of not more 30:70, the amount of incorporation in the mixed solvent of the relatively low viscosity petroleum-based hydrocarbon solvent can be secured, the generation of a high viscosity for the ink as a whole can be prevented, and the storage stability can be further improved.

In addition to at least one of the glycol ether-based solvent and the alkanediol-based solvent as described above, the ink may contain an other non-aqueous solvent within a range in which the compatibility between the petroleum-based hydrocarbon solvent and the fatty acid ester-based solvent may not be impaired and a single layer may be formed.

The other non-aqueous solvent can be exemplified by higher monohydric alcohol solvents having at least 6 and preferably 12 to 20 carbon atoms in each molecule, e.g., isomyristyl alcohol, isopalmityl alcohol, isostearyl alcohol, 1-octadecanol, oleyl alcohol, isoeicosyl alcohol, and decyltetradecanol, and by higher fatty acid solvents having at least 12 and preferably 14 to 20 carbon atoms in each molecule, e.g., lauric acid, isomyristic acid, palmitic acid, isopalmitic acid, a-linolenic acid, linoleic acid, oleic acid, and isostearic acid.

The magnetic ink can contain a dispersant. The dispersant can bring about a stable dispersion of the ferrite particles in the solvent.

The dispersant may be an anionic compound, a cationic compound, an amphoteric compound, or a nonionic compound, but a dispersant having a lipophilic group as well as a polar group that exhibits an affinity for ferrite particles is preferred. The polar group-bearing dispersant is preferably provided with an acidic group, a basic group, or a combination of both. The dispersant may be a low molecular weight compound or a high molecular weight compound, but from the standpoint of the stability in the ink the use is preferred of a polymeric dispersant that is a high molecular weight compound.

If hydroxy groups can be dealed to be present on the ferrite particle surface, these hydroxy groups on the ferrite particle surface are presumed to act as an acid or base depending on the metal element to which they are bonded. Since the adsorptivity of the dispersant to the ferrite particles is further increased by acid-base interaction with the hydroxy groups on the ferrite particle surface, a dispersant having an acid value, an amine value, or a combination thereof is preferably used for the dispersant.

For example, in the case of cobalt-containing ferrite particles, it is not entirely clear whether the hydroxy groups bonded to the cobalt act as an acid or act as a base, but the cobalt-bonded hydroxy groups are presumed to act as a base because the combination with a dispersant having an acid value is favorable. The same trend applies to the hydroxy groups bonded to manganese or iron. The use of a dispersant having an acid value is preferred in this case. On the other hand, when the amine value of the dispersant is too high, this acts to repel the ferrite particles and as a result the amine value of the dispersant is preferably limited.

A dispersant having an acid value and/or an amine value, while exhibiting a large acid-base interaction with the ferrite particles, tend to have a reduced solubility in non-aqueous solvent due to an increased polarity. Even in such a case, through the incorporation of at least one of the glycol ether-based solvent and the alkanediol-based solvent according to one embodiment, the solubility of the dispersant having an acid value and/or an amine value in the non-aqueous solvent can be increased and the dispersing effects can be further increased. Viewed from the standpoint of increasing the solubility of the dispersant in the non-aqueous solvent, the dispersant preferably has an acid value, and the dispersant more preferably has an amine value in a range such that its acid value is larger than its amine value.

The dispersant preferably has an acid value.

The acid value of the dispersant is preferably at least 1 mg KOH/g, more preferably at least 5 mg KOH/g, and still more preferably at least 10 mg KOH/g. While not being particularly limited, the acid value of the dispersant may not be more than 120 mg KOH/g or not more than 100 mg KOH/g.

This acid value is the number of milligrams of potassium hydroxide required to neutralize the total acidic component in 1 g of the nonvolatile fraction. This also applies in the following.

The dispersant may have an amine value.

The amine value of the dispersant is preferably not more than 15 mg KOH/g, more preferably not more than 10 mg KOH/g, and still more preferably not more than 5 mg KOH/g. While not being particularly limited, the amine value of the dispersant may be at least 1 mg KOH/g.

This amine value is the number of milligrams of potassium hydroxide equivalent to the hydrochloric acid required to neutralize the total basic component present in 1 g of the nonvolatile fraction. This also applies in the following.

The dispersant may have an acid value and an amine value. In this case, the acid value of the dispersant is preferably larger than its amine value, and the difference between the acid value and the amine value is preferably at least 1 mg KOH/g, more preferably at least 3 mg KOH/g, and still more preferably at least 5 mg KOH/g.

A dispersant having an acidic group can preferably be used for the dispersant having an acid value.

The acidic group can be, for example, a phosphoric acid group, carboxy group, sulfonic acid group, phosphate ester group, sulfate ester group, nitrate ester group, phosphorous acid group, phosphonic acid group, or sulfinic acid group. A phosphoric acid group, carboxy group, and phosphate ester group are preferred among the preceding. A single one of these may be present in each molecule or a combination of two or more may be present in each molecule.

The acidic group-bearing dispersant may be an oligomer, polymer, or low molecular weight compound.

For example, a poly(meth)acrylic resin, polyester resin, polyvinyl resin, or polyether resin may be used for the oligomer or polymer. A copolymer of the oligomers or monomers constituting these resins may also be used.

The acidic group may originate with the monomer constituting the oligomer or polymer and may be introduced bonded to the main chain or side chain of the particular constituent unit. The acidic group may also be introduced by the esterification of an oligomer or polymer using, for example, a phosphate ester.

When the acidic group-bearing dispersant is an oligomer or polymer, its weight-average molecular weight is preferably 500 to 10,000 and more preferably 1,000 to 5,000.

An acidic group-bearing polyester or an acidic group-bearing polyether can preferably be used for the acidic group-bearing dispersant.

The acidic group-bearing polyester can be exemplified by the phosphate esters, sulfate esters, nitrate esters, carbonate esters, and carboxylate esters of polyesters. Among these, the phosphate esters, sulfate esters, nitrate esters, carbonate esters, and carboxylate esters of polycaprolactone and polyvalerolactone can preferably be used. A multimer of a hydroxy group-bearing higher fatty acid, e.g., 12-hydroxystearic acid, can be used as the acidic group-bearing polyester.

The acidic group-bearing polyether can be exemplified by the phosphate esters, sulfate esters, nitrate esters, carbonate esters, and carboxylate esters of polyethers, such as polyethylene glycol and polypropylene glycol. The phosphate esters of polyethers can preferably be used among the preceding.

A low molecular weight compound, such as a higher fatty acid, e.g., 12-hydroxystearic acid, can be used as the acidic group-bearing dispersant.

A dispersant having a basic group can be used as the dispersant having an amine value.

Example of the basic groups include a primary, secondary, or tertiary amino group, an amide group, an imino group, a pyridyl group, and a pyrrolidone group, whereamong a primary, secondary, or tertiary amino group, imino group, pyrrolidone group, or the combination thereof is preferred.

The basic group-bearing dispersant can be exemplified by modified polyurethanes, basic group-containing poly(meth)acrylates, basic group-containing polyesters, polyesteramines, polyester polyamines, polyester polyimines, polyether polyamines, polyalkylolaminoamides and salts thereof, vinylpyrrolidone copolymers, salts of long-chain polyaminoamides and high molecular weight acid esters, salts of long-chain polyaminoamides and polar acid esters, copolymers of vinylpyrrolidone and long-chain alkenes, quaternary ammonium salts, alkylamine salts, such as stearylamine acetate, and fatty acid amine salts.

A block copolymer having an oleophilic block and a basic block can be used as the basic group-bearing dispersant, and, for example, a block copolymer can be used that has a first block containing a unit having an alkyl group having at least 12 carbon atoms and that has a second block containing a unit having a basic group.

The dispersant having the acidic group and the basic group as described above can be used as the dispersant having an acid value and an amine value.

The dispersant having an acid value and an amine value can be exemplified by dispersants provided by the introduction of a basic group into an acidic group-bearing polymer; the quaternary ammonium salts, alkylamine salts, and fatty acid amine salts of acidic group-bearing polymers; dispersants provided by the introduction of an acidic group into a basic group-bearing polymer; and dispersants provided by the esterification of a basic group-bearing polymer using, for example, a phosphate ester.

Commercial products that can be used as dispersants having an acid value include, for example, “Solsperse 3000, 21000, 36000, 41000”, manufactured by Lubrizol Japan Ltd.; “Hypermer KD-4, KD-8”, manufactured by Croda Japan KK; and “DISPERBYK2096”, manufactured by BYK-Chemie Japan KK.

Commercial products that can be used as the dispersant having an amine value or the dispersant having an acid value and an amine value can be exemplified by “Solsperse 9000, 11200, 13940, 16000, 17000, 18000, 19000, 24000, 32000, 38500, 39000, 71000, 22000, 28000” (all product names), manufactured by Lubrizol Japan Ltd.; “DISPERBYK-109, 2163, 2155, 9077” (all product names), manufactured by BYK-Chemie Japan KK; “Acetamin 24, 86” (both product names), manufactured by Kao Corporation; “Disparlon KS-860, KS-873N4” (both product names), manufactured by Kusumoto Chemicals, Ltd.; “Hypermer KD-3”, manufactured by Croda Japan KK; “Ajisper PB-821”, manufactured by Ajinomoto Fine-Techno Co., Inc.; “ANTARON V-216, V-220”, manufactured by International Specialty Products, Inc.; and “HINOACT KF1300M”, manufactured by Kawaken Fine Chemicals Co., Ltd.

Among the aforementioned dispersants having an acid value and an amine value, for example, “Solsperse 9000, 16000, 17000” and “Ajisper PB-821” can preferably be used as dispersants in which the acid value is larger than the amine value.

A nonionic dispersant may be used as the dispersant in place of or in addition to the aforementioned dispersant having an acid value and/or an amine value.

The nonionic dispersant can be exemplified by polyoxyethylene alkyl ether dispersants, polyoxypropylene alkyl ether dispersants, polyoxyethylene alkylphenyl ether dispersants, polyoxypropylene alkylphenyl ether dispersants, polyoxyethylene/fatty acid ester dispersants, polyoxypropylene/fatty acid ester dispersants, sorbitan/fatty acid ester dispersants, polyoxyethylene sorbitan/fatty acid ester dispersants, polyoxyethylene sorbitol/fatty acid ester dispersants, and glycerol/fatty acid ester dispersants.

A single one of these dispersants may be used alone or two or more may be used in combination.

An amount of the dispersant may be established as appropriate, as long as the amount can be sufficient to satisfactorily disperse the ferrite particles in the ink.

The dispersant can be blended, expressed as the mass ratio, at 0.01 to 1, preferably 0.05 to 0.5, and more preferably 0.1 to 0.3, in each case per 1 mass part of the ferrite particles.

The dispersant can be blended, with reference to the total amount of the ink, at 0.1 to 15 mass % and preferably 1 to 10 mass %.

In addition to the components described in the preceding, various additives may be incorporated in the magnetic ink as long as the effects of one invention are not impaired. For example, a nozzle clogging inhibitor, antioxidant, conductivity modifier, viscosity modifier, surface tension modifier, oxygen absorbent, and so forth may be added as appropriate as the additive. There are no particular limitations on the types of these additives, and the additives used in this field can be employed.

The ink can be produced by mixing the various components described in the preceding. The ink can be produced preferably by mixing and stirring the components, either all at once or divided out. Specifically, production can be carried out by introducing all of the components, either all at once or divided out, into a disperser, e.g., a bead mill, and carrying out dispersion, if desired, with passage through a filter, e.g., a membrane filter.

The method for printing with the oil-based magnetic ink is not particularly limited, and, for example, may be any of inkjet printing methods, offset printing methods, screen printing methods, gravure printing methods, and flexographic printing methods. Among these, inkjet printing methods are preferred because they do not include a step of contacting the recording medium and because they enable a convenient, on-demand, and wide-ranging image formation. In one embodiment, the oil-based magnetic ink is preferably used as an inkjet ink because of a low viscosity and an excellent storage stability.

There are no particular limitations on the method for printing using the inkjet ink as long as the magnetic ink can be jetted. When an inkjet recording device is used, preferably the ink according to one embodiment is jetted from an inkjet head based on a digital signal and the jetted ink droplets are adhered to a recording medium.

The favorable range for the viscosity of the inkjet ink will vary depending on, for example, the nozzle diameter of the inkjet head in the inkjet recording system and the jetting environment, but generally at 23° C. it is preferably 5 to 50 mPa·s, more preferably 10 to 40 mPa·s, and still more preferably about 10 to 35 mPa·s. Here, the ink viscosity is the value measured at 23° C. at 1000 s⁻¹ when the shear rate is varied from 1 s⁻¹ to 1000 s⁻¹.

There are no particular limitations on the recording medium in one embodiment, and printing papers and the like, such as plain paper, coated paper, specialty paper can be used.

Here, plain paper is paper in which, for example, an ink-receiving layer or film layer has not been formed on an ordinary paper. Plain paper can be exemplified by high-quality paper, medium-quality paper, PPC paper, woody paper, and recycled paper. In plain paper, the paper fibers, having a thickness of several μm to several tens of μm, form gaps of from several tens of μm to several hundred μm, and therefore ink permeation is facilitated with this paper.

Coated paper for inkjet service, such as matte paper, glossy paper, and semiglossy paper, as well as so-called coated printed paper, can preferably be used for the coated paper. Here, coated printed paper refers to printing paper that has traditionally been used in, for example, relief printing, offset printing, and gravure printing, and that has a coating layer, formed of a coating material containing a binder, such as starch and an inorganic pigment, such as clay or calcium carbonate, on the surface of a high-quality paper or medium-quality paper. In accordance with the amount of application of the coating material and the coating method, coated printing paper can be classified into fine coating paper, high-quality lightweight-coated paper, medium-quality lightweight-coated paper, high-quality coated paper, medium-quality coated paper, art paper, cast-coated paper, and the like.

### EXAMPLES

The present invention is described in greater detail in the following using Examples. The present invention is not limited to the Examples that follow.

[Ink Preparation]

The ink formulations are given in Table 1 to Table 3. The components were mixed in accordance with the component proportions given in the tables. This was followed by dispersion for 2 hours with a bead mill (“Rocking Mill RM-10”, manufactured by Seiwa Giken Co., Ltd.) set at 60 Hz to obtain the ink.

The ferrite particles used were prepared as follows.

(Manganese-Cobalt Ferrite)

A starting aqueous solution containing cobalt dichloride hexahydrate (CoCl₂.6H₂O), manganese dichloride tetrahydrate (MnCl₂.4H₂O), and ferric chloride hexahydrate (FeCl₃.6H₂O) was added to an aqueous sodium hydroxide solution; this mixed solution was stirred; and the magnetic particles that sedimented after stirring were isolated to obtain a manganese-cobalt ferrite.

(Cobalt Ferrite)

An aqueous sodium hydroxide solution was added to a starting aqueous solution containing cobalt nitrate hexahydrate and iron(III) nitrate nonahydrate and stirring was carried out for 20 minutes to produce an iron/cobalt coprecipitate. This coprecipitate was introduced into an autoclave and was heated for 4 hours at 260° C. The precipitate provided by the hydrothermal treatment was washed with water to obtain a cobalt ferrite.

(Magnetite)

An aqueous starting solution containing iron(II) sulfate heptahydrate and iron(III) nitrate nonahydrate was added dropwise to an aqueous sodium hydroxide solution, and a bubbling treatment with nitrogen gas was carried out while controlling to 25° C. or below to produce a coprecipitate of iron(II) and iron(III). This coprecipitate was introduced into an autoclave and a hydrothermal treatment was performed for 2 hours at 150° C. to obtain magnetite.

The following components were used.

Solsperse 16000: manufactured by Lubrizol Japan Ltd., acid value=20 mg KOH/g, amine value=1 mg KOH/g, active component=100 mass %.

Solsperse 3000: manufactured by Lubrizol Japan Ltd., acid value=33 mg KOH/g, amine value=0 mg KOH/g, active component=100 mass %.

Solsperse 18000: manufactured by Lubrizol Japan Ltd., acid value<5 mg KOH/g, amine value=2 mg KOH/g, active component=100 mass %.

Solsperse 9000: manufactured by Lubrizol Japan Ltd., acid value=20 mg KOH/g, amine value=17 mg KOH/g, active component=100 mass %.

Isopar L: petroleum-based hydrocarbon solvent, manufactured by Exxon Mobil Corporation.

AF-4: petroleum-based hydrocarbon solvent, manufactured by JXTG Nippon Oil & Energy Corporation.

Ethylhexyl isononanoate: “ES108109”, manufactured by Kokyu Alcohol Kogyo Co., Ltd.
Isodecyl neopentanoate: “Neolite 100P”, manufactured by Kokyu Alcohol Kogyo Co., Ltd.
Triethylene glycol monobutyl ether: manufactured by Tokyo Chemical Industry Co., Ltd.
Tetraethylene glycol monobutyl ether: “Butysenol 40”, manufactured by KH Neochem Co., Ltd.
Diethylene glycol monoethyl ether: manufactured by Tokyo Chemical Industry Co., Ltd.
1,5-Pentanediol: manufactured by Tokyo Chemical Industry Co., Ltd.
1,6-Hexanediol: manufactured by Tokyo Chemical Industry Co., Ltd.
2-Ethyl-1,3-hexanediol: “Octanediol”, manufactured by KH Neochem Co., Ltd.
1,10-Decanediol: manufactured by Tokyo Chemical Industry Co., Ltd.

[Evaluations]

Each of the aforementioned inks was evaluated using the following methods. The results of these evaluations are also given in the tables.

(Ink Viscosity)

Using a Rheometer MCR 102 (manufactured by Anton Paar GmbH), the ink viscosity was measured immediately after ink production by linearly varying the shear rate at 23° C. from 1 s⁻¹ to 1000 s⁻¹ over 60 seconds. The viscosity at a shear rate of 1 s⁻¹ and at a shear rate of 1000 s⁻¹ is given in the tables.

It is thought that the initial adsorptivity of the dispersant to the ferrite particles can be predicted from the viscosity at a shear rate of 1 s⁻¹. The viscosity of the ink as a whole can be identified using the viscosity at a shear rate of 1000 s⁻¹.

(Storage Stability)

The ink viscosity was first measured immediately after ink production. The ink was then introduced into a screw-cap vial and was stored for 2 weeks at 70° C. The ink was then sampled and the post-storage ink viscosity was measured. The percentage change in the ink viscosity was calculated using the following formula and was evaluated using the following criteria. The viscosity measurement was carried out by the same method as indicated above for the ink viscosity, and the viscosity value at 1000 s⁻¹ was used in the following formula.

Viscosity change (%)=[(Post-storage viscosity−Viscosity immediately after production)/Viscosity immediately after production]×100
A: The absolute value of the viscosity change is not more than 3%.
B: The absolute value of the viscosity change is more than 3% and not more than 5%.
C: The absolute value of the viscosity change is more than 5%.

TABLE 1
Ink Formulations and Results of Evaluations

| Unit: mass % | | Ex. 1 | Ex. 2 | Ex. 3 | Ex. 4 | Ex. 5 | Ex. 6 | Ex. 7 | Ex. 8 |
|---|---|---|---|---|---|---|---|---|---|
| Ferrite particle | Manganese-cobalt | 41.5 | 41.5 | 41.5 | 41.5 | 41.5 | 41.5 | 41.5 | 41.5 |
| | ferrite | | | | | | | | |
| | Cobalt ferrite | — | — | — | — | — | — | — | — |
| | Magnetite | — | — | — | — | — | — | — | — |
| Dispersant | Solsperse 16000 (acid | 5.4 | 5.4 | — | — | 5.4 | — | 5.4 | 5.4 |
| | value 20, amine value 1) | | | | | | | | |
| | Solsperse 3000 (acid | — | — | 4.1 | 4.1 | — | — | — | — |
| | value 33, amine value 0) | | | | | | | | |
| | Solsperse 18000 (acid | — | — | — | — | — | 6.2 | — | — |
| | value <5, amine value | | | | | | | | |
| | 2) | | | | | | | | |
| | Solsperse 9000 (acid | — | — | — | — | — | — | — | — |
| | value 20, amine value | | | | | | | | |
| | 17) | | | | | | | | |
| Petroleum-based | Isopar L | 31.9 | 31.9 | 32.6 | 32.6 | 31.9 | 31.4 | 41.8 | — |
| hydrocarbon | AF-4 | — | — | — | — | — | — | — | 31.9 |
| solvent | | | | | | | | | |
| Fatty acid | Ethylhexyl isononanoate | 17.7 | 19.4 | 18.3 | 20.0 | 17.7 | 17.4 | 7.8 | — |
| ester-based | Isodecyl neopentanoate | — | — | — | — | — | — | — | 17.7 |
| solvent | | | | | | | | | |
| Glycol | Triethylene glycol | 3.5 | 1.8 | 3.5 | 1.8 | — | 3.5 | 3.5 | 3.5 |
| ether-based | monobutyl ether | | | | | | | | |
| solvent | Tetraethylene glycol | — | — | — | — | 3.5 | — | — | — |
| | monobutyl ether | | | | | | | | |
| | Diethylene glycol | — | — | — | — | — | — | — | — |
| | monoethyl ether | | | | | | | | |
| Total (mass %) | | 100.0 | 100.0 | 100.0 | 100.0 | 100.0 | 100.0 | 100.0 | 100.0 |
| Petroleum-based hydrocarbon | | 64:36 | 62:38 | 64:36 | 62:38 | 64:36 | 64:36 | 84:16 | 64:36 |
| solvent:fatty acid ester- | | | | | | | | | |
| based solvent, mass ratio | | | | | | | | | |
| Evaluations | 1 s⁻¹ viscosity (mPa · s) | 50.1 | 49.7 | 91.5 | 90.2 | 50.5 | 72.7 | 48.6 | 47.6 |
| | 1000 s⁻¹ viscosity | 30.3 | 29.6 | 25.5 | 25.3 | 30.2 | 30.8 | 28.1 | 27.2 |
| | (mPa · s) | | | | | | | | |
| | Storage stability | A | A | A | A | A | B | B | A |

Ex.: Example

TABLE 2
Ink Formulations and Results of Evaluations

| | | | | | Comp. | Comp. | Comp. | Comp. |
|---|---|---|---|---|---|---|---|---|
| Unit: mass % | | Ex. 9 | Ex. 10 | Ex. 11 | Ex. 1 | Ex. 2 | Ex. 3 | Ex. 4 |
| Ferrite particle | Manganese-cobalt | 41.5 | — | — | 41.5 | 41.5 | 41.5 | 41.5 |
| | ferrite | | | | | | | |
| | Cobalt ferrite | — | 41.5 | — | — | — | — | — |
| | Magnetite | — | — | 41.5 | — | — | — | — |
| Dispersant | Solsperse 16000 | — | 5.4 | 5.4 | 5.4 | 5.4 | 5.4 | 5.4 |
| | (acid value 20, | | | | | | | |
| | amine value 1) | | | | | | | |
| | Solsperse 3000 | — | — | — | — | — | — | — |
| | (acid value 33, | | | | | | | |
| | amine value 0) | | | | | | | |
| | Solsperse 18000 | — | — | — | — | — | — | — |
| | (acid value <5, | | | | | | | |
| | amine value 2) | | | | | | | |
| | Solsperse 9000 | 5.4 | — | — | — | — | — | — |
| | (acid value 20, | | | | | | | |
| | amine value 17) | | | | | | | |
| Petroleum-based | Isopar L | 31.9 | 31.9 | 31.9 | 31.9 | 49.6 | — | 31.9 |
| hydrocarbon | AF-4 | — | — | — | — | — | — | — |
| solvent | | | | | | | | |
| Fatty acid | Ethylhexyl | 17.7 | 17.7 | 17.7 | 21.2 | — | 49.6 | 17.7 |
| ester-based | isononanoate | | | | | | | |
| solvent | Isodecyl | — | — | — | — | — | — | — |
| | neopentanoate | | | | | | | |
| Glycol | Triethylene glycol | 3.5 | 3.5 | 3.5 | — | 3.5 | 3.5 | — |
| ether-based | monobutyl ether | | | | | | | |
| solvent | Tetraethylene | — | — | — | — | — | — | — |
| | glycol monobutyl | | | | | | | |
| | ether | | | | | | | |
| | Diethylene glycol | — | — | — | — | — | — | 3.5 |
| | monoethyl ether | | | | | | | |
| Total (mass %) | | 100.0 | 100.0 | 100.0 | 100.0 | 100.0 | 100.0 | 100.0 |
| Petroleum-based hydrocarbon | | 64:36 | 64:36 | 64:36 | 60:40 | 100:0 | 0:100 | 64:36 |
| solvent:fatty acid ester- | | | | | | | | |
| based solvent, mass ratio | | | | | | | | |
| Evaluations | 1 s⁻¹ viscosity | 34.3 | 54.2 | 50.3 | 49.3 | 160.2 | 138.6 | 50.6 |
| | (mPa · s) | | | | | | | |
| | 1000 s⁻¹ viscosity | 27.0 | 26.5 | 27.1 | 29.5 | 61.0 | 42.8 | 29.7 |
| | (mPa · s) | | | | | | | |
| | Storage stability | B | A | A | C | C | C | C |

Ex.: Example
Comp. Ex.: Comparative Example

TABLE 3
Ink Formulations and Results of Evaluations

| | | | | | | | Comp. |
|---|---|---|---|---|---|---|---|
| Unit: mass % | | Ex. 12 | Ex. 13 | Ex. 14 | Ex. 15 | Ex. 16 | Ex. 5 |
| Ferrite particle | Manganese-cobalt | 41.5 | 41.5 | 41.5 | 41.5 | 41.5 | 41.5 |
| | ferrite | | | | | | |
| Dispersant | Solsperse 16000 | 5.4 | 5.4 | 5.4 | 5.4 | 5.4 | 5.4 |
| | (acid value 20, amine | | | | | | |
| | value 1) | | | | | | |
| Petroleum- | Isopar L | 31.9 | 31.9 | 31.9 | 31.9 | 31.9 | 31.9 |
| based | | | | | | | |
| hydrocarbon | | | | | | | |
| solvent | | | | | | | |
| Fatty acid | Ethylhexyl | 17.7 | 19.5 | 19.5 | 19.5 | 20.4 | 19.5 |
| ester-based | isononanoate | | | | | | |
| solvent | | | | | | | |
| Alkanediol- | 1,5-Pentanediol | — | — | — | — | — | 1.7 |
| based solvent | 1,6-Hexanediol | — | — | 1.7 | — | — | — |
| | 2-Ethyl-l,3- | 3.5 | 1.7 | — | — | 0.8 | — |
| | hexanediol | | | | | | |
| | 1,10-Decanediol | — | — | — | 1.7 | — | — |
| Total (mass %) | | 100.0 | 100.0 | 100.0 | 100.0 | 100.0 | 100.0 |
| Petroleum-based solvent:fatty acid | | 64:36 | 62:38 | 62:38 | 62:38 | 61:39 | 62:38 |
| ester-based solvent, mass ratio | | | | | | | |
| Evaluations | 1 s⁻¹ viscosity | 54.2 | 52.6 | 51.8 | 51.9 | 50.7 | 51.4 |
| | (mPa · s) | | | | | | |
| | 1000 s⁻¹ viscosity | 32.8 | 32.2 | 32.2 | 32.6 | 30.9 | 31.9 |
| | (mPa · s) | | | | | | |
| | Storage stability | A | A | B | A | B | C |

Ex.: Example
Comp. Ex.: Comparative Example

As shown in the tables, in each of the Examples the ink had an excellent storage stability.

A petroleum-based hydrocarbon solvent, fatty acid ester-based solvent, and glycol ether-based solvent are used in Examples 1 to 11.

Excellent results were obtained in Examples 3 and 4 although the type of dispersant was different. According to the results for Examples 1 and 2 and Examples 3 and 4, by having the dispersant have an amine value along with an acid value, the ink assumes a low initial viscosity expressed as the viscosity value at 1 s⁻¹ and an improved adsorptivity by the dispersant to the ferrite particles can be recognized.

Excellent results were obtained in Example 5, which used a different type of glycol ether-based solvent.

Excellent results were obtained in Example 6, which used a different type of dispersant. According to the results for Example 1 and Example 6, a further improvement in the storage stability can be recognized when the acid value of the dispersant is at least 5 mg KOH/g.

Excellent results were obtained in Example 7, which is an example in which the petroleum-based hydrocarbon solvent is blended in large amounts. According to the results for Example 1 and Example 7, an additional improvement in the storage stability can be recognized for the blending of the fatty acid ester-based solvent in large amounts at a mass ratio between the petroleum-based hydrocarbon solvent and fatty acid ester-based solvent of 80 : 20 or greater.

Excellent results were obtained in Example 8, which is an example in which the petroleum-based hydrocarbon solvent and fatty acid ester-based solvent are both different.

Excellent results were obtained in Example 9, which used a different type of dispersant. According to the results for Example 1 and Example 9, an additional improvement in the storage stability can be recognized when the amine value of the dispersant is not more than 15 mg KOH/g.

Excellent results were obtained in Examples 10 and 11, which used different types of ferrite particles.

Comparative Example 1 did not contain the glycol ether-based solvent and the alkanediol-based solvent and had a reduced storage stability.

Comparative Example 2 did not contain a fatty acid ester-based solvent and had a reduced dispersion stability for the ferrite particles and a reduced storage stability. The initial viscosity was also high.

The initial viscosity of the ink, expressed as the viscosity value at 1 s⁻¹, is high in Comparative Example 2. Here, it is thought that the absence of the fatty acid ester-based solvent results in a reduction in the solubility of the dispersant in the solvent and in a failure to obtain a satisfactory closeness between the dispersant and ferrite particle, and thus results in a decline in the initial ferrite particle dispersibility.

In Comparative Example 3, the petroleum-based hydrocarbon solvent was not incorporated and the fatty acid ester-based solvent was blended in large amounts, and the viscosity of the ink as a whole was increased and the storage stability was reduced.

The initial viscosity of the ink, expressed as the viscosity value at 1 s⁻¹, is high in Comparative Example 3. Here, it is thought that the absence of the petroleum-based hydrocarbon solvent results in a large blending amount for the fatty acid ester-based solvent and an increase in the initial viscosity of the ink.

In Comparative Example 4, the R¹ in the glycol ether-based solvent has a small number of carbon atoms and due to this the effect of improving the storage stability was not obtained.

The petroleum-based hydrocarbon solvent, fatty acid ester-based solvent, and alkanediol-based solvent are used in Examples 12 to 16.

Examples 12, 13, and 16 are examples that have different blending amounts for the alkanediol-based solvent, and excellent results were obtained. Moreover, an additional improvement in the storage stability can be recognized for Examples 12 and 13, in which the blending amount of the alkanediol-based solvent is at least 1 mass %.

Excellent results were obtained in Examples 13 to 15, which are examples that use different alkanediol-based solvents. Moreover, an additional improvement in the storage stability can be recognized for Examples 13 and 15, in which the number of carbon atoms in the alkanediol-based solvent is at least 7.

The effect of improving the storage stability was not obtained in Comparative Example 5 due to the low number of carbon atoms in the alkanediol-based solvent.

It is to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. An oil-based magnetic ink comprising:
ferrite particles;
a dispersant;
a petroleum-based hydrocarbon solvent;
a fatty acid ester-based solvent; and
at least one selected from the group consisting of a glycol ether-based solvent and an alkanediol-based solvent, wherein
the glycol ether-based solvent is a compound represented by R¹O—(R²O)ₘ—H where R¹ is an alkyl group having 4 to 8 carbon atoms, R² is an alkylene group having 2 or 3 carbon atoms, and m is 3 or 4, and the alkanediol-based solvent is an alkanediol-based solvent having 6 to 10 carbon atoms.

2. The oil-based magnetic ink according to claim 1, wherein the dispersant has an acid value of at least 5 mg KOH/g.

3. The oil-based magnetic ink according to claim 1, wherein the dispersant has an amine value of not more than 15 mg KOH/g.

4. The oil-based magnetic ink according to claim 1, wherein the dispersant has an acid value of at least 5 mg KOH/g, and an amine value of not more than 15 mg KOH/g.

5. The oil-based magnetic ink according to claim 1, wherein a mass ratio between the petroleum-based hydrocarbon solvent and the fatty acid ester-based solvent is 80:20 to 30:70.

6. The oil-based magnetic ink according to claim 1, wherein the ink is an inkjet ink.

7. The oil-based magnetic ink according to claim 1, wherein the ink comprises the glycol ether-based solvent.

8. The oil-based magnetic ink according to claim 7, wherein the dispersant has an acid value of at least 5 mg KOH/g.

9. The oil-based magnetic ink according to claim 7, wherein the dispersant has an amine value of not more than 15 mg KOH/g.

10. The oil-based magnetic ink according to claim 7, wherein the dispersant has an acid value of at least 5 mg KOH/g, and an amine value of not more than 15 mg KOH/g.

11. The oil-based magnetic ink according to claim 7, wherein a mass ratio between the petroleum-based hydrocarbon solvent and the fatty acid ester-based solvent is 80:20 to 30:70.

12. The oil-based magnetic ink according to claim 7, wherein the ink is an inkjet ink.

13. The oil-based magnetic ink according to claim 1, wherein the ink comprises the alkanediol-based solvent.

14. The oil-based magnetic ink according to claim 13, wherein the dispersant has an acid value of at least 5 mg KOH/g.

15. The oil-based magnetic ink according to claim 13, wherein the dispersant has an amine value of not more than 15 mg KOH/g.

16. The oil-based magnetic ink according to claim 13, wherein the dispersant has an acid value of at least 5 mg KOH/g, and an amine value of not more than 15 mg KOH/g.

17. The oil-based magnetic ink according to claim 13, wherein a mass ratio between the petroleum-based hydrocarbon solvent and the fatty acid ester-based solvent is 80:20 to 30:70.

18. The oil-based magnetic ink according to claim 13, wherein the ink is an inkjet ink.

19. A method of manufacturing a printed item comprising: jetting an ink to a recording medium by using an inkjet printing method, wherein the ink is the oil-based magnetic ink according to claim 7.

20. A method of manufacturing a printed item comprising: jetting an ink to a recording medium by using an inkjet printing method, wherein the ink is the oil-based magnetic ink according to claim 13.
